(19) United States
(12) Patent Application Publication
(10) Pub. No.: US 2015/0192281 A1
(43) Pub. Date: Jul. 9, 2015

(54) LIGHT EMISSION DEVICE, AND ILLUMINATION DEVICE

(71) Applicant: SHARP KABUSHIKI KAISHA, Osaka-shi, Osaka (JP)

(72) Inventors: Yuta Homma, Osaka-shi (JP); Makoto Agatani, Osaka-shi (JP); Toshio Hata, Osaka-shi (JP); Tomokazu Nada, Osaka-shi (JP)

(21) Appl. No.: 14/413,083

(22) PCT Filed: Jun. 10, 2013
(86) PCT No.: PCT/JP2013/065982

§ 371 Date: Jan. 6, 2015

(30) Foreign Application Priority Data
Jul. 9, 2012 (JP) 2012-154109

(51) Int. Cl. F21V 21/00; F21V 19/00

(52) U.S. Cl. CPC F21V 21/00; F21V 19/002; F21Y 2101/02

(57) ABSTRACT

The light emission device (1a) includes an insulating substrate (2) and a light-emitting section (5) which is provided on a main surface of the insulating substrate (2) and has an LED chip (3) and a wiring pattern (4). In an edge area of the main surface of the insulating substrate (2), a wall pattern (7a) made of an insulating material is provided so as to surround the light-emitting section (5).

### TECHNICAL FIELD

The present invention relates to (i) a light emission device in which a light-emitting element is provided on a surface of a substrate, (ii) an illumination device, and (iii) an insulating substrate.

### BACKGROUND ART

In recent years, in view of energy saving and long life, a technique is rapidly spreading in which a light emission device that has, as a light source, a solid light-emitting element such as an LED (light emitting diode) is used in an illumination device or the like. Such light emission devices have been proposed in large numbers, and, in particular, a COB (Chip On Board) light emission device 10 is well known in which an LED chip 3 that is a light-emitting element is provided on an insulating substrate 2 (see FIG. 7).

Such a light emission device is attached to a heat sink so that heat generated due to light emission can be efficiently radiated. The heat sink is made of metal (e.g., Cu) which has high thermal conductivity. Therefore, it is necessary to secure a creepage distance for electrically insulating between a wiring pattern on the substrate and the heat sink.

As a conventional COB light emission device, for example, Patent Literature 1 discloses a light emission device in which a size of a module substrate and a size of a recessed part of a metallic module supporting member are defined such that electrical insulation between a wiring pattern on the module substrate and the metallic member around a light emission module is secured. Moreover, Patent Literature 2 discloses an LED light source unit in which (i) thermal conductivity of an adhesion member for fixing a printed circuit board to a heat radiating member and (ii) a withstand voltage between a fixation surface of the printed circuit board and a fixation surface of the heat radiating member is defined.

### CITATION LIST

### Patent Literature

### [Patent Literature 1]

Japanese Patent Application Publication Tokukai No. 2012-9780 (Publication date: Jan. 12, 2012)

### [Patent Literature 2]

International Publication No. WO 2007/139195 (International publication date: Dec. 6, 2007)

### SUMMARY OF INVENTION

### Technical Problem

However, according to the conventional COB light emission device, a periphery (i.e., cut part) of a substrate is cracked or chipped when being divided into pieces by cutting (dicing), and it is therefore difficult to secure the creepage distance between the wiring pattern on the substrate and the metallic member around the substrate. Moreover, there has been no configuration for checking, at a low cost, whether or not the creepage distance is secured. Particularly, in recent years, a size of the light-emitting element is getting smaller, and accordingly a size of the light emission device itself is getting smaller, and it is therefore difficult to secure the creepage distance.

The present invention is accomplished in view of the problem, and its object is to provide a light emission device and the like that (i) can secure a predetermined creepage distance between a wiring pattern on an insulating substrate and a conductive member which is provide around the insulating substrate (ii) makes it possible to check the predetermined creepage distance.

### Solution to Problem

A light emission device of the present invention includes: an insulating substrate; a light-emitting section provided on a main surface of the insulating substrate, the light-emitting section having a light-emitting element and a wiring pattern; and a wall section provided in an edge area of the main surface of the insulating substrate so as to surround the light-emitting section.

### Advantageous Effects of Invention

According to the light emission device of the present invention, the wall section serves as a marker for checking whether or not a creepage distance enough to maintain an insulating property is secured. That is, by checking whether or not the wall section is chipped or cracked, it is possible to check whether or not the predetermined creepage distance can be secured with respect to a conductive member provided around the insulating substrate. Moreover, by providing the wall section made of the insulating material, it is possible to gain a creepage distance, by a convex part of the wall section, longer than that in a flat state in which only the insulating substrate is provided.

Moreover, by eliminating a light emission device that cannot secure the predetermined creepage distance, it is possible to selectively use only light emission devices that can secure the predetermined creepage distance. By thus using the light emission device that can secure the predetermined creepage distance, it is possible to prevent leakage, and this makes it possible to prevent breakage or accidental ignition in the light emission device or in an illumination device that includes the light emission device.

As is clear from above, the configuration of the light emission device in accordance with the present invention can provide the high quality light emission device that can assure safety and is high in reliability.

### BRIEF DESCRIPTION OF DRAWINGS

(a) of FIG. 1 is a top view of a light emission device in accordance with Embodiment 1 of the present invention, and (b) of FIG. 1 is a cross-sectional view of the light emission device taken along the line A-A in (a) of FIG. 1.

FIG. 2 is a view for explaining, in each of (a) and (b), a creepage distance.

FIG. 3 is a top view of a light emission device in accordance with Embodiment 2 of the present invention.

FIG. 4 is a top view of a light emission device in accordance with Embodiment 3 of the present invention.

FIG. 5 is a view illustrating another example of a wall pattern of the present invention.

FIG. 6 is a top view of another light emission device of the present invention.

FIG. 7 is a top view of a conventional light emission device.

### DESCRIPTION OF EMBODIMENTS

The following description will discuss an embodiment of the present invention with reference to FIGS. 1 through 6. Note that the present invention is not limited to this.

### Embodiment 1

### Configuration of Light Emission Device

(a) of FIG. 1 is a top view illustrating an example configuration of a light emission device 1a in accordance with the present embodiment. Moreover, (b) of FIG. 1 is a cross-sectional view of the light emission device 1a taken along the line A-A in (a) of FIG. 1. As illustrated in FIG. 1, the light emission device 1a includes an insulating substrate 2 and a light-emitting section 5 that is provided on a main surface of the insulating substrate 2 and has an LED chip (light-emitting element) 3 and a wiring pattern 4. That is, the light emission device 1 is a COB light emission device in which a light-emitting element is provided on a substrate.

The light emission device 1a further includes a sealing resin (sealant) 6a surrounded by a damming resin (damming member) 6b, a land electrode 8, and a wall pattern (wall section) 7a.

According to the present embodiment, the insulating substrate 2 is a substrate that is made of ceramic. A material of the insulating substrate 2 is not limited to ceramic and, for example, a metal core substrate can be used in which an insulating layer is provided on a surface of a metal substrate. In such a case, it is possible to employ a configuration in which the insulating layer is formed only in an area in which the wiring pattern 4 is formed, and a plurality of LED chips 3 are provided directly on the surface of the metal substrate. A main surface (upper surface) and a rear surface (lower surface) of the insulating substrate 2 have a rectangular shape but are not limited to the rectangular shape.

The LED chip 3 is not limited to a particular one and can be, for example, a blue LED chip having an emission peak wavelength of 450 nm or an ultraviolet (near-ultraviolet) LED chip having an emission peak wavelength of 390 nm to 420 nm. A plurality of LED chips 3 are fixed to the main surface of the insulating substrate 2 with an adhesive agent or the like. In (a) of FIG. 1, a circuit is illustrated in which 6 series circuit sections, each of which is made up of 3 LED chips 3 connected in series with each other, are connected in parallel with each other. Note, however, that the circuit configuration is not limited to this.

The wiring pattern 4 is wiring via which an electric current is supplied to the LED chips 3. For example, the wiring pattern 4 is made of Au or Cu. According to the present embodiment, two wiring patterns are arranged in parallel with each other. One of the two wiring patterns is connected with a land electrode 8 on a cathode side, and the other of the two wiring patterns is connected with a land electrode 8 on an anode side. Note that a material and a shape of the wiring pattern 4 are not limited to these.

Electrical connection between the LED chips 3 and electrical connection between (i) the LED chips 3 and (ii) the wiring patterns 4 are made by wire bonding. As a wire, for example, an Au wire can be used. Note that a method for arranging the LED chips 3 is not limited to the wire bonding and, for example, flip chip bonding can be used.

The land electrode 8 is an electrode for applying a voltage to the light emission device 1a. For example, the land electrode 8 is made of Ag—Pt, and is provided in an end of the main surface of the insulating substrate 2.

The sealing resin 6a is a sealant that covers the LED chips 3. The sealing resin 6a is formed by, for example, hardening a liquid silicone resin in which a particulate fluorescent substance is dispersed. The sealing resin 6a illustrated in (b) of FIG. 1 is formed to be flat. Note, however, that a shape of the sealing resin 6a is not limited to flat, and a degree of convexity can be adjusted by adjusting viscosity of the resin. For example, the sealing resin 6a can be formed into a convex shape having a smooth curved surface.

The damming resin 6b surrounds the sealing resin 6a so as to keep the shape of the sealing resin 6a. The sealing resin 6a is referred to also as “resin dam” and serves as a frame when the sealing resin 6a is formed.

The damming resin 6b is made of a resin that has a low optical transmittance or has a light reflecting property and can be made of, for example, a white silicone resin prepared by mixing, as a light diffusion filler, titanium oxide (IV) with a base material that is a light-transmitting silicone resin. Note that the light diffusion filler is not limited to titanium oxide (IV). A material of the damming resin 6b is not limited to the above material and can be, for example, acrylic resin, urethane resin, epoxy resin, polyester resin, acrylonitrile butadiene styrene (ABS) resin, polycarbonate (PC) resin, or the like. A color of the damming resin 6b is not limited to white and can be, for example, milk white. When the resin is colored in white or milk white, it is possible to cause the resin to have a low optical transmittance or a light reflecting property. In order to minimize an area in which the sealing resin 6a is formed, the damming resin 6b is preferably formed so as to cover the wiring patterns 4.

The wall pattern 7a is made of an insulating material and is formed in an edge area of the main surface of the insulating substrate 2 so as to surround the light-emitting section 5. The wall pattern 7a can be made of a material which is identical with that of the damming resin 6b. For example, a white silicone resin can be used which has been prepared by mixing, as a light diffusion filler, titanium oxide (IV) with a base material that is a light-transmitting silicone resin. Alternatively, the wall pattern 7a can be made of a solder resist.

According to the light emission device 1a that includes the wall pattern 7a, the wall pattern 7a serves as a marker for checking whether or not a creepage distance enough to maintain an insulating property is secured. That is, by checking whether or not the wall pattern 7a is chipped or cracked, it is possible to confirm whether or not a predetermined creepage distance can be secured with respect to the conductive member such as the heat sink which is provided around the insulating substrate 2.

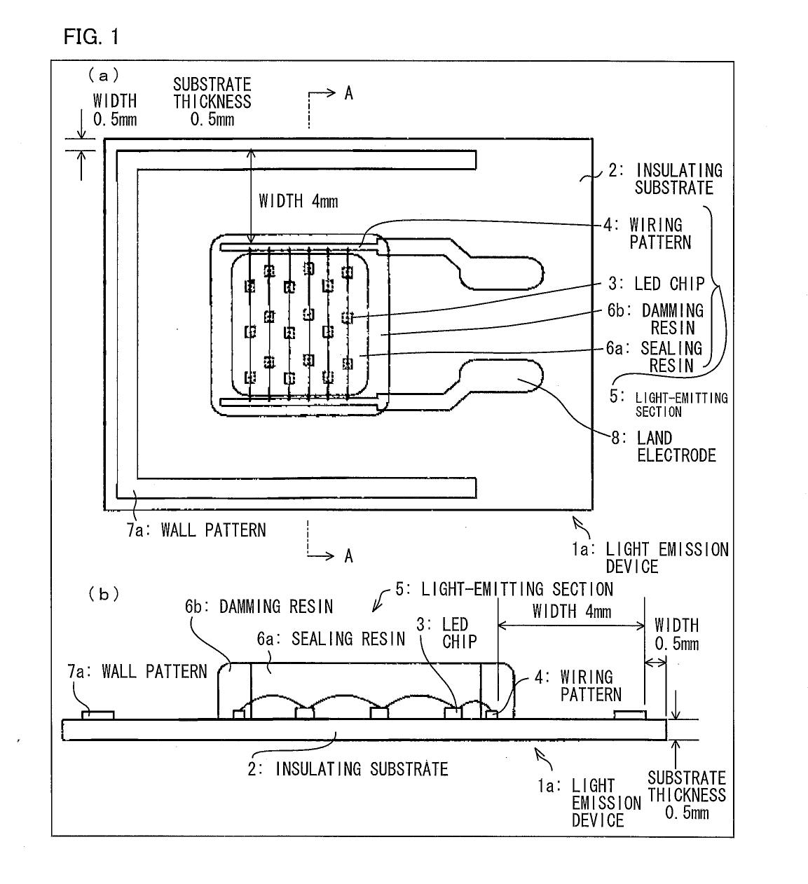

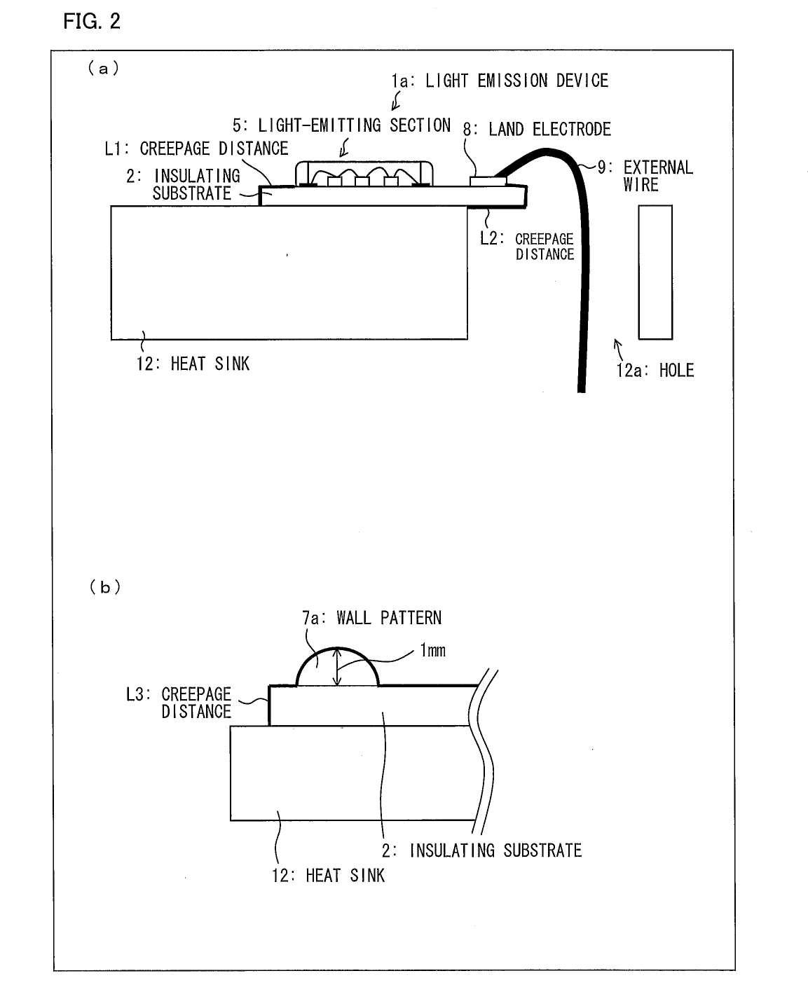

Moreover, by providing the wall pattern 7a made of an insulating material, it is possible to gain a creepage distance, by a convex part of the wall pattern 7a, longer than that in a flat state in which only the insulating substrate 2 is provided. The following description will explain this effect with reference to FIG. 2. As compared with a creepage distance L1 (see (a) of FIG. 2) from the wiring pattern 4 to the heat sink 12 on which the light emission device 1 is provided, a creepage distance L3 (see (b) of FIG. 2) is longer by a distance of a surface of the wall pattern 7a. In a case where a cross section of the wall pattern 7a in a shorter-side direction is a semicircular shape with a radius of 1 mm, the creepage distance L3 is longer than the creepage distance L1 by πr−2r (i.e., flat part of the insulating substrate 2)=1.14 mm. Note that the cross section of the wall pattern 7a in the shorter-side direction is not limited to the semicircular shape and can be, for example, a rectangular shape or a triangular shape.

As later described, it is possible to selectively use only the light emission device 1a, which can secure a predetermined creepage distance, by eliminating a light emission device that cannot secure the predetermined creepage distance after manufacturing light emission devices by dividing a parent substrate into pieces. By thus using the light emission device 1a that can secure the predetermined creepage distance, it is possible to prevent leakage, and this makes it possible to prevent breakage or accidental ignition in the light emission device 1a or in an illumination device that includes the light emission device 1a.

As is clear from above, the light emission device 1a is a high quality device that can assure safety and is high in reliability.

Here, it is preferable that the wall pattern 7a is formed at a location at which a predetermined creepage distance can be secured between the insulating substrate 2 and a part of the wiring pattern 4 which part is nearest to a periphery of the main surface of the insulating substrate 2. By thus forming the wall pattern 7a, the other part of the wiring pattern 4 (i.e., a part other than the part of the wiring pattern 4 which part is nearest to the periphery of the main surface of the insulating substrate 2) can surely secure, with respect to the periphery of the main surface of the insulating substrate 2, a distance longer than the predetermined creepage distance. Therefore, any part of the wiring pattern 4 on the insulating substrate 2 can secure a distance equal to or longer than the predetermined creepage distance, and it is therefore possible to further assure safety.

Moreover, according to the light emission device 1a of the present embodiment, the wall pattern 7a is not provided around the land electrodes 8 (see (a) of FIG. 1). This is because, as illustrated in (a) of FIG. 2, an external wire to be connected to the land electrode may be caused to pass through a hole 12a that is formed in the heat sink 12 at a location under the land electrode 8. In this case, it is possible to lengthen a creepage distance L2 from the land electrode 8 to the heat sink 12. Therefore, in such a configuration, the wall pattern 7a does not need to be provided around the land electrodes 8. By thus not providing the wall pattern 7a around the land electrodes 8, it is possible to form the wall pattern 7a at a reduced cost.

A shortest distance from the wall pattern 7a to the periphery of the main surface of the insulating substrate 2 can be equal to a thickness of the insulating substrate 2. In a case where the shortest distance is thus equal to the thickness and a crack or a chip caused in the periphery of the insulating substrate 2 reaches the wall pattern 7a, it is possible to easily grasp that the crack or the chip, whose size is equivalent to the thickness of the insulating substrate 2, has been caused. The wall pattern 7a is formed, and it is therefore possible to easily find a defect in the light emission device 1a.

The following describes an example of dimensions of the light emission device 1 that has the above described configuration.

Insulating substrate 2: outer dimensions of 15 mm×12 mm; thickness of 0.5 mm
Damming resin 6b: width of 1 mm; outer dimensions of 8 mm×8 mm; height of 1 mm
Wall pattern 7a: width of 1 mm; height of 1 mm
A distance from a lateral surface of the wiring pattern 4, which surface is nearest to the periphery of the main surface of the insulating substrate 2, to a lateral surface of the wall pattern 7a which surface is nearest to the periphery of the main surface of the insulating substrate 2: 4.0 mm
A distance from a lateral surface of the wall pattern, which surface is nearest to the periphery of the main surface of the insulating substrate 2, to the periphery of the main surface of the insulating substrate 2: 0.5 mm
Note that these dimensions are merely an example.

In the above description, the damming resin 6b is formed so as to cover the wiring patterns 4. In a case where the damming resin 6b is formed in a location on the outer side of the wiring patterns 4, it is possible to gain a creepage distance by the damming resin 6b.

### Manufacturing Method

The following description will briefly discuss a method for manufacturing the light emission device 1a having the above described configuration. Note that the light emission device 1a is formed from one (1) large insulating substrate (parent substrate, not illustrated) which has a plurality of light emission device areas, and the light emission device 1a is one of pieces that have been obtained by dicing (dividing) peripheries of the plurality of light emission device areas in the end of the manufacturing process.

First, wiring patterns 4 and land electrodes 8 are formed on a main surface of the parent substrate. Next, LED chips 3 are die-bonded to the main surface of the parent substrate, and then wire bonding is carried out by the use of a wire.

Subsequently, a damming resin 6b and a wall pattern 7a are formed on the main surface of the parent substrate. Specifically, the damming resin 6b and the wall pattern 7a are formed by drawing with a white liquid silicone resin (containing 10% of silica and 3% of titanium oxide (IV)) and hardening the white liquid silicone resin by heat.

By thus simultaneously forming the damming resin 6b and the wall pattern 7a, a height of the wall pattern 7a can be set to be identical with a height of the damming resin 6b. In this case, it is possible to manufacture the light emission device 1a with a reduced number of steps, as compared with a case where the damming resin 6b and the wall pattern 7a are formed separately. Moreover, it is possible to gain a creepage distance by the height of the wall pattern 7a.

Subsequently, a sealing resin 6a is formed on the main surface of the parent substrate. Specifically, an area surround by the damming resin 6b is filled, by the use of a dispenser, with a liquid silicone resin containing a particulate fluorescent substance, and the liquid silicone resin is then hardened by heat. Lastly, the light emission device areas are separated by dicing the parent substrate into separate light emission devices 1a, and thus each of the light emission devices 1a is obtained. According to the manufacturing method, it is possible to easily manufacture the light emission device 1a at a low cost.

In this case, by checking the wall pattern 7a, it is possible to check whether or not a predetermined creepage distance can be secured with respect to a metallic member (e.g., heat sink) provided around each of the light emission devices 1a. That is, in a case where a wall pattern 7a is chipped or cracked, such a light emission device cannot secure the predetermined creepage distance. From this, by eliminating such a light emission device that cannot secure the predetermined creepage distance, it is possible to selectively use only light emission devices 1a that can secure the predetermined creepage distance.

Note that the wall pattern 7a and the damming resin 6b do not need to be formed simultaneously. In this case, the wall pattern 7a is formed by printing a resist called solder resist and then hardening the resist by heat. Here, the resist is preferably colored. In a case where the resist is green, the insulating substrate 2 is milk white, and the insulating substrate 2 is cracked or chipped, it is advantageously possible to easily recognize such crack or chip with eyes. According to the configuration, it is possible to more easily find the crack or chip, as compared with a case where the wall pattern 7a is milk white and the insulating substrate 2 is milk white or white. In a case where the wall pattern 7a is thus formed by printing, there is an advantage that the wall patterns 7a can be formed at the same time at a low cost, although the wall patterns 7a do not become so high.

Alternatively, the wall pattern 7a can be formed by attaching a shaped sheet, which has been prepared in accordance with a shape of the wall pattern 7a, to the main surface of the parent substrate. The shaped sheet is a sheet of fluorocarbon rubber or silicone rubber, and can have an adhesive sheet on a side on which the main surface is to be attached.

Instead of using resin, the damming resin 6b can also be formed by attaching a shaped sheet, which has been prepared in accordance with a shape of the damming resin 6b, to the main surface of the parent substrate. The shaped sheet is a sheet of fluorocarbon rubber or silicone rubber, and can have an adhesive sheet on a side on which the main surface is to be attached. In a case of the method in which the shaped sheet is attached to the main surface of the parent substrate, the shaped sheet can be ultimately removed, depending on an intended light-distribution characteristic of the light emission device 1a.

The sealing resin 6a is not limited to the method in which the area surround by the damming resin 6b is filled with the sealing resin 6a with the use of the dispenser. The sealing resin 6a can be formed not by using the damming resin 6b but by, for example, compression molding or transfer molding with the use of a die such that the LED chips 3, the wiring patterns 4, and the like are sealed together by a light-transmitting resin containing a fluorescent substance.

According to the manufacturing method, the wire bonding is carried out after the LED chips 3 are provided, and then the damming resin 6b is formed. Note, however, that the present embodiment is not limited to this, and it is possible to employ a method in which the damming resin 6b is formed first and then the LED chips 3 are provided and the wire bonding is carried out.

Next, the following description will discuss other embodiments of the present invention, with reference to the drawings. Note that configurations other than what is described in each of the embodiments are identical with those of Embodiment 1. Moreover, for convenience of explanation, in each of the embodiments, the same reference numerals are given to constituent members having functions identical to those illustrated in the drawings of Embodiment 1, and descriptions of such constituent members are omitted.

### Embodiment 2

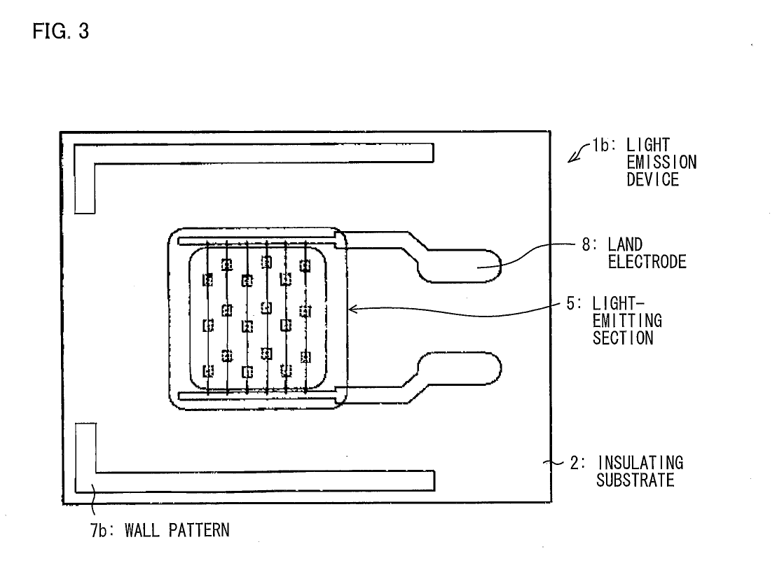

FIG. 3 is a top view illustrating an example configuration of a light emission device 1b in accordance with the present embodiment. The light emission device 1b of the present embodiment is different from the light emission device 1a of Embodiment 1 in a shape of a wall pattern. The other configurations and shapes are identical with those of the light emission device 1a of Embodiment 1.

As illustrated in FIG. 3, a wall pattern 7b of the light emission device 1b of the present embodiment has a shape obtained by deleting, from the wall pattern 7a of the light emission device 1a of Embodiment 1, a wall pattern that exists in an edge area of the insulating substrate 2 which edge area faces an area in which the wiring patterns 4 of the light-emitting section 5 are not provided. As such, according to the light emission device 1b, there is an additional area in which no wall pattern is provided, and it is therefore possible to form the wall pattern 7b with a lower cost.

In other words, the wall pattern 7b has a shape in which walls are provided (i) in edge areas of the insulating substrate 2 which edge areas face the respective wiring patterns 4 and (ii) in corner parts of the main surface of the insulating substrate 2. When dividing into pieces, corner parts of the insulating substrate 2 are more likely to be cracked or chipped. Under the circumstances, by providing the wall pattern 7b in the corner parts of the insulating substrate 2, it is possible to appropriately check assurance of a creepage distance in a part in which a crack or a chip is easily caused.

### Embodiment 3

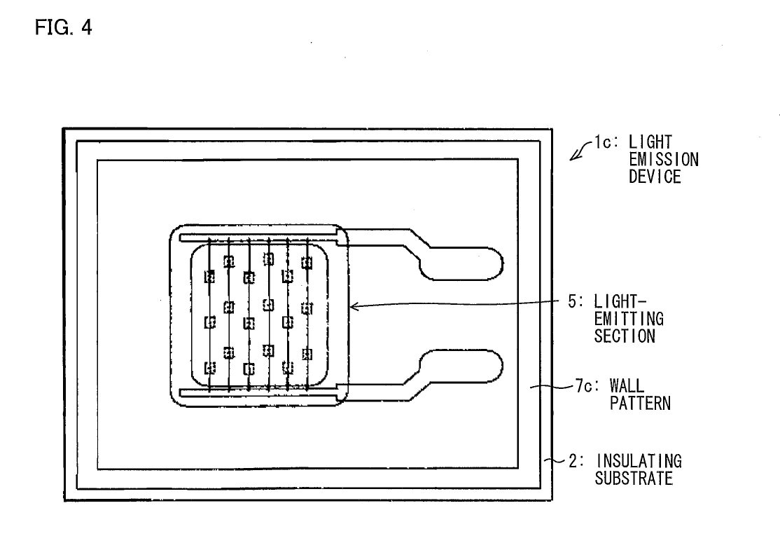

FIG. 4 is a top view illustrating an example configuration of a light emission device 1c in accordance with the present embodiment. The light emission device 1c of the present embodiment is different from the light emission device 1a of Embodiment 1 in a shape of a wall pattern. The other configurations and shapes are identical with those of the light emission device 1a of Embodiment 1.

A wall pattern 7c of the light emission device 1c of the present embodiment is provided in a whole circumference in an edge area of the main surface of the insulating substrate 2. That is, walls are provided around the land electrodes 8, in addition to the shape of the wall pattern 7a of the light emission device 1a in accordance with Embodiment 1. By thus providing the wall pattern 7c in the whole circumference in the edge area of the main surface of the insulating substrate 2, it is possible to surely secure a creepage distance in the whole circumference of the insulating substrate 2.

### Embodiment 4

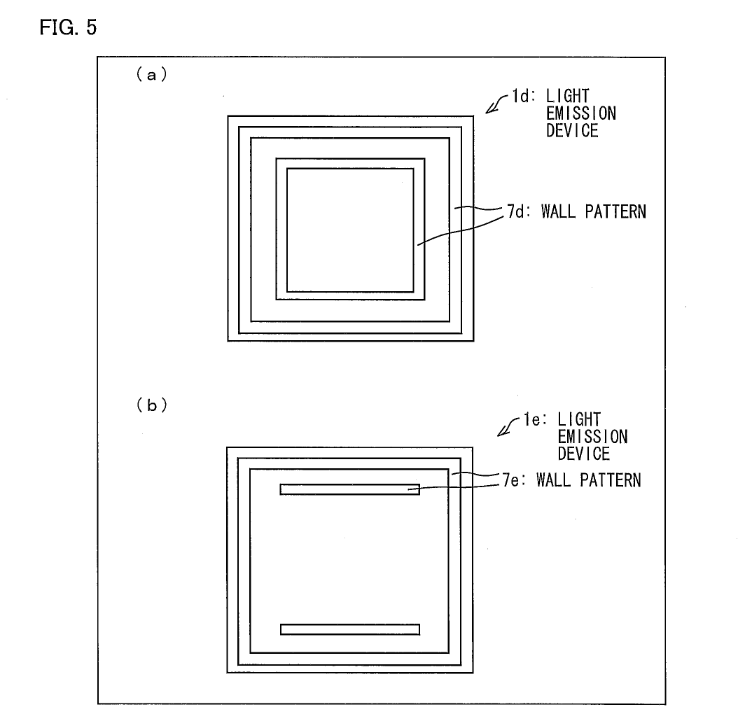

(a) and (b) of FIG. 5 are top views illustrating example configurations of respective of a light emission device 1d and a light emission device le in accordance with the present embodiment. Each of the light emission device 1d and the light emission device le of the present embodiment is different from the light emission device 1a of Embodiment 1 in a shape of a wall pattern. The other configurations and shapes are identical with those of the light emission device 1a of Embodiment 1. Note that, in FIG. 5, the light-emitting section and the land electrode are not illustrated.

According to the light emission device 1d of the present embodiment, double walls of a wall pattern 7d are provided in the whole circumference in the edge area of the main surface of the insulating substrate 2 (see (a) of FIG. 5). Alternatively, according to the light emission device 1d of the present embodiment, a wall pattern 7e includes (i) a wall that is providing in the whole circumference in the edge area of the main surface of the insulating substrate 2 and (ii) walls that are provided inside the above wall and in locations facing the respective wiring patterns (see (b) of FIG. 5). That is, in each of edge areas of the insulating substrate 2 facing the respective wiring patterns 4, double walls of the wall pattern 7e are provided.

As above described, each of the wall patterns 7d and 7e includes multiple walls that are arranged in a surface direction of the main surface and surround the light-emitting section 5. From this, a creepage distance from the wiring pattern is increased by a distance of plurality of convex parts formed in the wall pattern 7d or 7e, and it is therefore possible to further gain the creepage distance. In the above description, the number of walls is double. Note, however, that the number of walls can be a larger number. In a case where double or more walls are formed, it is preferable to use a solder resist. The solder resist achieves formation accuracy higher than that of a silicone resin, and it is therefore possible to sufficiently control a width of a resist and a space between resists. This makes it possible to check the creepage distance (i.e., a distance from and end of the insulating substrate 2) more accurately. Of course, a silicone resin or other insulating material can be used.

### Embodiment 5

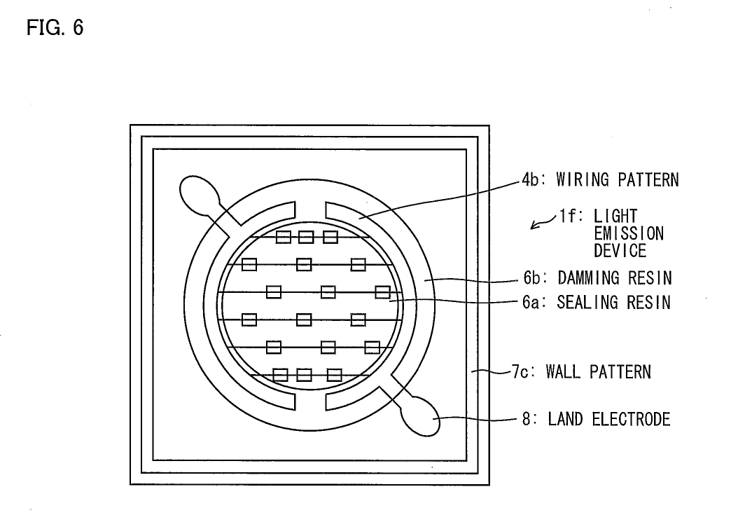

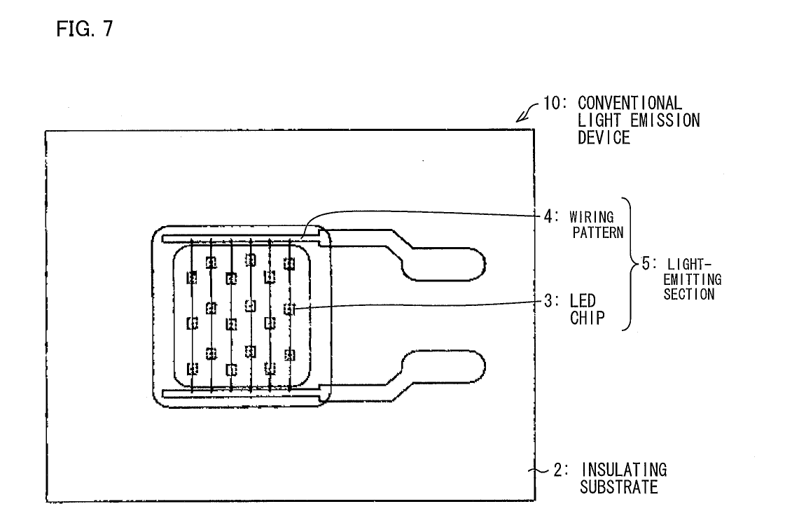

FIG. 6 is a top view illustrating an example configuration of a light emission device 1f in accordance with the present embodiment. The light emission device 1f of the present embodiment is different from the light emission device 1c of Embodiment 3 in a shape of a wiring pattern. The other configurations and shapes are identical with those of the light emission device 1c of Embodiment 3.

The light emission device 1f of the present embodiment includes a wiring pattern 4b whose shape is a ring-like shape (see FIG. 6). In accordance with this, a damming resin 6b provided above the wiring pattern 4b also has a ring-like shape, and a sealing resin 6a provided inside the damming resin 6b has a circular shape.

According to the present embodiment, the wall pattern 7c is provided in a whole circumference in the edge area of the main surface of the insulating substrate 2, as with Embodiment 3. Alternatively, the wall pattern 7c can include multiple walls that are arranged in the surface direction of the main surface of the insulating substrate 2. Alternatively, the wall pattern 7c can have a shape in which no wall is provided in the vicinity of the land electrodes 8.

In Embodiments 1 through 5, 2 patterns of the shape of the wiring pattern are described. Note, however, that the shape of the wiring pattern is not limited to those described above. Moreover, the circuit configuration in which the LEDs are connected with the wiring patterns is also not limited to the configuration above described.

The present invention is not limited to the embodiments, but can be altered by a skilled person in the art. An embodiment derived from a proper combination of technical means disclosed in respective different embodiments is also encompassed in the technical scope of the present invention.

### Main Points

The light emission device of the present invention includes: an insulating substrate; a light-emitting section provided on a main surface of the insulating substrate, the light-emitting section having a light-emitting element and a wiring pattern; and a wall section provided in an edge area of the main surface of the insulating substrate so as to surround the light-emitting section.

According to the configuration, the wall section made of an insulating material is provided in the edge area of the main surface of the insulating substrate so as to surround the light-emitting section. In the configuration, the wall section serves as a marker for checking whether or not a creepage distance enough to maintain an insulating property is secured. That is, by checking whether or not the wall section is chipped or cracked, it is possible to check whether or not the predetermined creepage distance can be secured with respect to the conductive member (metallic member) provided around the insulating substrate. Moreover, by providing the wall section made of the insulating material, it is possible to gain a creepage distance, by a convex part of the wall section, longer than that in a flat state in which only the insulating substrate is provided.

Moreover, by eliminating a light emission device that cannot secure the predetermined creepage distance, it is possible to selectively use only light emission devices that can secure the predetermined creepage distance. By thus using the light emission device that can secure the predetermined creepage distance, it is possible to prevent leakage, and this makes it possible to prevent breakage or accidental ignition in the light emission device or in an illumination device that includes the light emission device.

As is clear from above, the configuration of the present invention can provide the high quality light emission device that can assure safety and is high in reliability.

According to the light emission device of the present invention, in addition to the above described configuration, the wall section can be provided at a location at which a predetermined creepage distance is secured between the wall section and a part of the wiring pattern which part is nearest to a periphery of the main surface.

According to the configuration, the wall section is provided at a location at which a predetermined creepage distance is secured between the wall section and the part of the wiring pattern which part is nearest to the periphery of the main surface. By thus forming the wall section, the other part of the wiring pattern (i.e., a part other than the part of the wiring pattern which part is nearest to the periphery of the main surface) can surely secure, with respect to the periphery, a distance longer than the predetermined creepage distance. Therefore, any part of the wiring pattern on the insulating substrate can secure a distance equal to or longer than the predetermined creepage distance, and it is therefore possible to further assure safety.

According to the light emission device of the present invention, in addition to the above described configuration, it is possible that the wall section is not provided around a land electrode that is connected with the wiring pattern.

An external wire to be connected to the land electrode may be caused to pass through a hole that is formed in the heat sink (conductive base) at a location under the land electrode. In this case, it is possible to lengthen a creepage distance from the land electrode to the heat sink (see (a) of FIG. 2). Therefore, in such a configuration, the wall section does not need to be provided around the land electrode. By thus not providing the wall section around the land electrode, it is possible to form the wall section at a reduced cost.

Moreover, according to the configuration in which the wall section is not provided in the vicinity of the land electrode, the wall section will not hinder soldering of the external wire to the land electrode. Further, the wall section will not hinder providing a connector terminal and the like on the land electrode. By thus not providing the wall section in the vicinity of the land electrode, it is possible to bring about an advantage that the land electrode can be easily connected with the other members.

According to the light emission device of the present invention, in addition to the above described configuration, it is possible that the wall section is not provided at a location in the edge area which location faces an area in which the wiring pattern of the light-emitting section is not provided.

According to the configuration, the wall section is not provided at a location in the edge area which location faces an area in which the wiring pattern of the light-emitting section is not provided, and it is therefore possible to form the wall section at a reduced cost.

According to the light emission device of the present invention, in addition to the above described configuration, the wall section can be provided (i) at a location in the edge area which location faces an area in which the wiring pattern of the light-emitting section is provided and (ii) at a corner part of the main surface.

When dividing into pieces, a corner part of the insulating substrate is more likely to be cracked or chipped. Under the circumstances, by providing the wall section in the corner parts of the insulating substrate, it is possible to appropriately check assurance of a creepage distance in a part in which a crack or a chip is easily caused.

Alternatively, according to the light emission device of the present invention, in addition to the above described configuration, the wall section can be provided in a whole circumference in the edge area of the main surface of the insulating substrate.

According to the configuration, the wall section is provided in the whole circumference in the edge area of the main surface of the insulating substrate, and it is therefore possible to surely secure a creepage distance in the whole circumference of the insulating substrate.

Moreover, according to the light emission device of the present invention, in addition to the above described configuration, a shortest distance between the wall section and the periphery of the insulating substrate can be equal to a thickness of the insulating substrate.

According to the configuration, the shortest distance between the wall section and the periphery of the insulating substrate is equal to the thickness of the insulating substrate. Therefore, in a case where a crack or a chip is caused at the periphery of the insulating substrate and reaches the wall section, it is possible to easily grasp that the crack or the chip, whose size is equivalent to the thickness of the insulating substrate, has been caused. The wall section is formed, and it is therefore possible to easily find a defect in the light emission device.

According to the light emission device of the present invention, in addition to the above described configuration, it is possible that the light-emitting section further has (i) a sealing resin that covers the light-emitting element and (ii) a damming resin formed around the sealing resin; and a height of the wall section is equal to a height of the damming resin.

According to the configuration, the height of the wall section is equal to the height of the damming resin, and it is therefore possible to simultaneously form the damming resin and the wall section. In this case, it is possible to manufacture the light emission device with a reduced number of steps, as compared with a case where the damming resin and the wall section are formed separately. Moreover, it is possible to gain a creepage distance by the height of the wall section.

According to the light emission device of the present invention, in addition to the above described configuration, it is possible that the wall section includes multiple walls that are arranged in a surface direction of the main surface and surround the light-emitting section.

According to the configuration, the wall section includes multiple walls that are arranged in the surface direction of the main surface and surround the light-emitting section. From this, a creepage distance from the wiring pattern is increased by a distance of plurality of convex parts formed in the wall section, and it is therefore possible to further gain the creepage distance.

Moreover, in a case where the damming resin is formed in a location on the outer side of the wiring pattern, it is possible to gain a creepage distance by the damming resin.

In order to attain the object, the illumination device of the present invention includes any of the above described light emission devices and an illumination apparatus to which the light emission device is attached.

According to the configuration, a predetermined creepage distance from the wiring pattern on the insulating substrate to a conductive member provided around the insulating substrate is assured, and it is therefore possible to provide the illumination device which has been manufactured in consideration of safety.

The illumination device of the present invention includes: the light emission device; and a conductive base on which the light emission device is provided, a hole being provided in a part of the conductive base which part corresponds to the location in the edge area of the insulating substrate at which location the wall section is not provided.

According to the configuration, it is possible to cause an external wire, which is connected to the land electrode, to pass through the hole in the conductive base (e.g., heat sink). The wall section is not provided around the land electrode, and therefore the wall section will not hinder the passing of the external wire through the hole.

In order to attain the object, the insulating substrate of the present invention has, on its main surface, a plurality of light emission device areas in each of which a light-emitting section including a light-emitting element and a wiring pattern is provided, light emission devices being to be obtained from the insulating substrate by cutting the plurality of light emission device areas into the respective light emission devices, wherein: in each of the plurality of light emission device areas before being cut, a wall section that surrounds the light-emitting section is provided on an inner side than a cutting location in a surface direction of the main surface.

According to the configuration, in each of the plurality of light emission device areas of the insulating substrate, the wall section that surrounds the light-emitting section is provided on the inner side than the cutting location in the surface direction of the main surface. From this, by checking the wall section when the plurality of light emission device areas are divided into the respective light emission devices by cutting, it is possible to check whether or not a predetermined creepage distance can be secured between each of the light emission devices and a conductive member which is to be provided around the light emission device. That is, in a case where a wall section is chipped or cracked, such a light emission device cannot secure the predetermined creepage distance. Therefore, by eliminating such a light emission device that cannot secure the predetermined creepage distance, it is possible to selectively use only light emission devices that can secure the predetermined creepage distance.

Therefore, according to the configuration, it is possible to provide the insulating substrate from which the light emission devices, which can secure the predetermined creepage distance, can be adequately obtained.

### INDUSTRIAL APPLICABILITY

The present invention can be effectively used in (i) a light emission device including a solid light-emitting element as a light source, (ii) an illumination apparatus including the light emission device, and (iii) a parent substrate which is an insulating substrate from which light emission devices are cut out.

### REFERENCE SIGNS LIST

1a, 1b, 1c, 1d, and 1f: Light emission device
2: Insulating substrate
3: LED chip (light-emitting element)
4: Wiring pattern
5: Light-emitting section
6a: Sealing resin
6b: Damming resin
7a, 7b, 7c, 7d, 7e, and 7f: Wall pattern (wall section)
8: Land electrode
10: Conventional light emission device
12: Heat sink (conductive base)

1. A light emission device comprising:
an insulating substrate;
a light-emitting section provided on a main surface of the insulating substrate, the light-emitting section having a light-emitting element and a wiring pattern; which are surrounded by a damming member; and
a wall section made of an insulating material, the wall section being provided in an edge area of the main surface of the insulating substrate so as to surround the light-emitting section,
the wall section being provided directly on the main surface of the insulating substrate.

2. The light emission device as set forth in claim 1, wherein:
the wall section is provided at a location at which a predetermined creepage distance is secured between the wall section and a part of the wiring pattern which part is nearest to a periphery of the main surface.

3. The light emission device as set forth in claim 1, wherein:
the wall section is not provided around a land electrode that is connected with the wiring pattern.

4. The light emission device as set forth in claim 1, wherein:
the wall section is not provided at a location in the edge area which location faces an area in which the wiring pattern of the light-emitting section is not provided.

5. The light emission device as set forth in claim 1, wherein:
the wall section is provided (i) at a location in the edge area which location faces an area in which the wiring pattern of the light-emitting section is provided and (ii) at a corner part of the main surface.

6. The light emission device as set forth in claim 1, wherein:
the wall section is provided in a whole circumference in the edge area of the main surface of the insulating substrate.

7. The light emission device as set forth in claim 1, wherein:
a shortest distance between the wall section and the periphery of the main surface is equal to a thickness of the insulating substrate.

8. The light emission device as set forth in claim 1, wherein:
the light-emitting section further has a sealant that covers the light-emitting element inside the damming member; and
a height of the wall section is equal to a height of the damming member.

9. The light emission device as set forth in claim 1, wherein:
the wall section includes multiple walls that are arranged in a surface direction of the main surface and surround the light-emitting section.

10. The light emission device as set forth in claim 1, wherein:
the wall section is made of a silicone resin or a solder resist.

11. An illumination device comprising:
a light emission device recited in claim 1; and
an illumination apparatus to which the light emission device is attached.

12. An illumination device comprising:
a light emission device recited in claim 3; and
a conductive base on which the light emission device is provided,
a hole being provided in a part of the conductive base which part corresponds to the location in the edge area of the insulating substrate at which location the wall section is not provided.

13. (canceled)
